(19) United States
(12) Patent Application Publication
(10) Pub. No.: US 2003/0163364 A1
(43) Pub. Date: Aug. 28, 2003

(54) Net delta change in inventory management

(76) Inventors: Lee W. Piercy, Swindon (GB); David B. Webb, Kings Somberne (GB)

Correspondence Address: PILLSBURY WINTHROP, LLP, P.O. BOX 10500, MCLEAN, VA, 22102, US

(21) Appl. No.: 10/084,494

(22) Filed: Feb. 28, 2002

(51) Int. Cl. G06F 17/60

(52) U.S. Cl. 705/10

(57) ABSTRACT

An arrangement is provided for supply line management. An inventory projection is first generated based on supply line information. Net delta recommendations are then generated utilizing the supply line information and the inventory projection to refine the invetory projection.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to inventory management. Other aspects of the present invention relate to automated inventory management.

High productivity often requires effective inventory management. An assembly line can not sustain productivity if parts to be assembled are not supplied promptly. On the other hand, if supply is more than what is needed, the cost of storing and maintaining unused supplies drives the cost high and decreases the profit. In modem days, collaborative processes are aimed at improving the quality of inventory management. For example, a customer, who buys parts from a manufacturer, may communicate its consumption patterns to the manufacturer so that the manufacturer can deliver parts in a manner that is consistent with its customer's consumption schedules.

With the advancement of computer technologies, more inventory management mechanisms have been automated and provide efficient platforms, accessible to both customers and manufacturers, that allow multiple parties to collaboratively participate the process of inventory management. With such platforms, customers may provide an inventory management system with information that is relevant to their consumption. Examples of such information may include types and quantities of needed products, consumption sites (locations), and dates on which products have to be made available at specified locations.

On the other hand, through the same platform, a manufacturer may analyze its customer's information and devise delivery schedules to meet its customer's consumption needs. Further interaction between a customer and a manufacture may include that the manufacturer may inform its customers about delivery schedule. With such feedback information, the customer is able to take into account of the products that are currently in a transit state.

With adequate amount of information, an inventory management system may project a customer's inventory needs and deliver products proactively to ensure prompt inventory supply. While such inventory management systems may improve the flow, there are problems associated with them. For example, when inventory projection is generated solely based on individual daily consumption needs, the projected inventory may become sensitive to any slight change. Subsequently, when adapting to a change, an inventory management system may generate a plurality of different inventory projections, which may not only cause confusion to its users but, more importantly, also introduce inefficiency and high cost.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 depicts a high-level architecture of a supply line management system, which provides inventory net delta change recommendations to a user, according to embodiments of the present invention;

FIG. 2 illustrates exemplary types of supply line information, according to an embodiment of the present invention;

FIG. 3 is an exemplary flowchart of a process, in which a supply line management system provides inventory net delta change recommendations to a user, according to embodiments of the present invention;

FIG. 4 depicts the internal high level functional block diagram of a net delta recommendation mechanism, according to embodiments of the present invention;

FIG. 5 is an exemplary flowchart of a process, in which a net delta recommendation mechanism generates net delta recommendations, according to embodiments of the present invention;

FIG. 6 is an exemplary flowchart of a process, in which a net delta change adjustment mechanism updates net delta changes to meet an inventory target, according to an embodiment of the present invention;

FIG. 7 depicts the internal structure of a net delta change generation mechanism and its relationship with a net delta change aggregation mechanism and with a net delta change buffering mechanism, according to an embodiment of the present invention;

FIG. 8 is an exemplary flowchart of a process, in which a net delta change control mechanism determines appropriate processing based on excursion condition, according to an embodiment of the present invention;

FIG. 9 is an exemplary flowchart of a process, in which a below minimum excursion handler handles a below minimum excursion condition, according to an embodiment of the present invention;

FIG. 10 is an exemplary flowchart of a process, in which an above maximum excursion handler handles an above maximum excursion condition, according to an embodiment of the present invention;

FIG. 11 is an exemplary flowchart of a process, in which a below minimum aggregation mechanism aggregates net delta changes made to handle a below minimum excursion condition, according to an embodiment of the present invention;

FIG. 12 is an exemplary flowchart of a process, in which n above maximum aggregation mechanism aggregates net delta changes made to handle an above maximum excursion condition, according to an embodiment of the present invention;

FIG. 13 is an exemplary flowchart of a process, in which a below minimum buffering mechanism buffers net delta changes made to handle a below minimum excursion condition, according to an embodiment of the present invention; and

FIG. 14 is an exemplary flowchart of a process, in which n above maximum buffering mechanism buffers net delta changes made to handle an above maximum excursion condition, according to an embodiment of the present invention.

### DETAILED DESCRIPTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

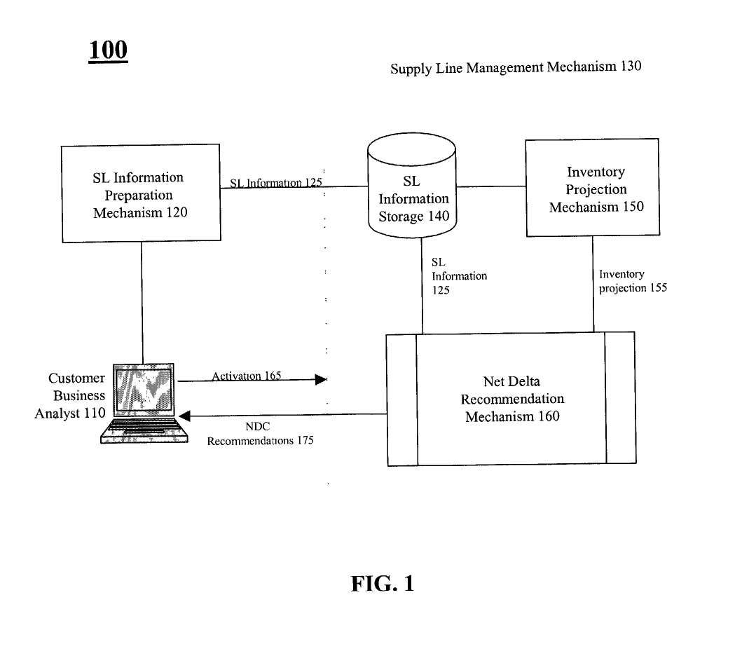

FIG. 1 depicts a high-level architecture of a supply line management system 100, which provides inventory net delta change recommendations to a user, according to embodiments of the present invention. System 100 comprises a customer business analyst 110 as a user of the system, a supply line information preparation mechanism 120, and a supply line management mechanism 130. The customer business analyst 110 interacts with the supply line information preparation mechanism 120 to define necessary information needed to manage an inventory supply line. The pre-prepared supply line information 125 may be stored in the supply line management mechanism 130. When the customer business analyst 110 activates (165) the supply line management mechanism 130, it generates net delta change (NDC) recommendations 175 made based on the supply line information 125.

The supply line management mechanism 130 in FIG. 1 further includes a supply line information storage 140, an inventory projection mechanism 150, and a net delta recommendation mechanism 160. The supply line information 125 prepared by the supply line information preparation mechanism 120 is stored in the supply line information storage first used by the inventory projection mechanism 150 to produce an inventory projection 155 over an appropriate period. The net delta recommendation mechanism 160 then takes both the supply line information 125 and the inventory projection 155 as input and generates the NDC recommendations 175.

The customer business analyst 110 may correspond to a personnel who is responsible for ensuing customers with a streamline of supplies in a manner that satisfies the customers' needs. For example, a manufacturer of computer chips may deliver its products (computer chips) to various computer manufacturers that use the computer chips to assemble personal computers. In this case, the chip manufacturer may provide facilities to make sure that the computer chips are shipped to its customers' (computer manufacturers) sites on time according to the customers' production schedule. In this case, the customer business analyst 110 may correspond to the personnel representing the chip manufacturer to schedule the shipping according to known customer production information. That is, the customer business analyst's responsibility is to make sure that the inventory at the customers' production sites is accordance with the customers' needs for production.

The customer business analyst 110 interacts with the supply line information preparation mechanism 120 to gather customer information or supply line information 125 that is relevant to the customers' inventory requirements. Such interaction may be through a computer system on the customer business analyst's location connecting to a computer at a different location that implements the supply line information preparation mechanism 120. The communication between the customer business analyst 110 and the supply line information preparation mechanism 120 may be through a network such as the Internet or a wireless network. The communication interface between the customer business analyst 110 and the supply line information preparation mechanism 120 may be implemented as a user graphical interface (GUI) such as a web interface or a proprietary application interface. It is also possible that the customer business analyst 110 operates directly on the computer system that implements the supply line preparation mechanism 120. In this case, the customer business analyst 110 may locate at the same location as the supply line information preparation mechanism 120.

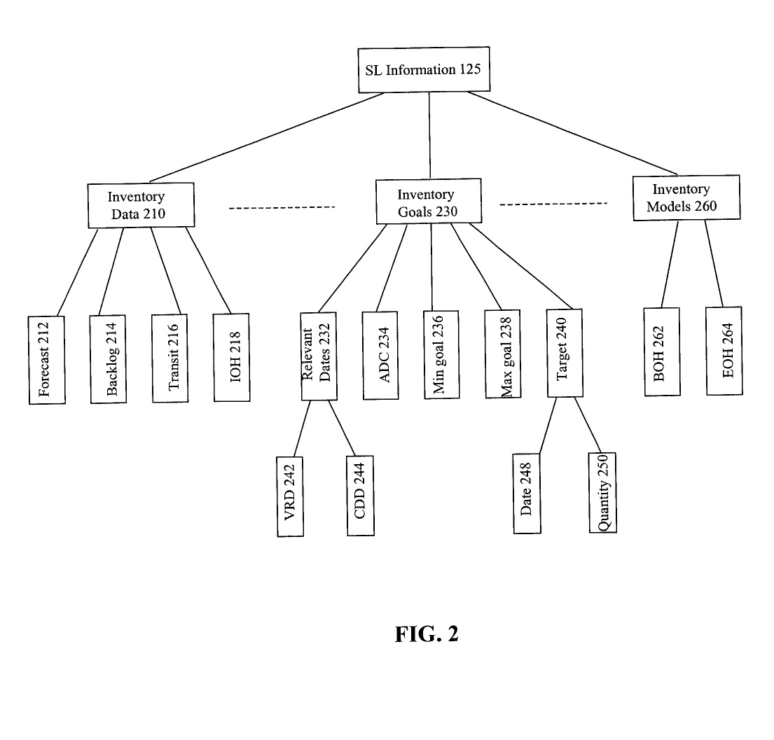

FIG. 2 illustrates exemplary types of supply line information 125. The supply line information 125 may include inventory data 210, inventory goals 230, and inventory models 260. The inventory data 210 may include inventory forecast 212, inventory backlog 214, inventory transit 216, and inventory on hand (IOH) 218. The inventory on hand 218 may refer to the amount of the inventory that is currently at a customer production site. The inventory transit 216 may refer to the amount of inventory that is currently being shipped to the customer but has not yet arrived at the customer's production site. The inventory backlog 214 may refer to the amount of inventory that is backlogged. The inventory forecast 212 may refer to the amount of inventory that is needed according to current estimation of the production condition.

The inventory goals 230 relates to the desired inventory targets, which may include relevant target dates 232, average daily consumption (ADC) 234, minimum inventory goal 236, maximum inventory goal 238, and specific target 240 such as on a particular date 248 the inventory quantity 250 has to be at certain fixed amount. The relevant dates 232 may include, for example, valid receiving date (VRD) 242 and confirmed delivery date (CDD) 244.

To ensure a steady streamline supply of inventory according to customers' production schedules, customers may also need to indicate specific inventory models to be used in their inventory maintenance. For example, the inventory models 260 may include an inventory model called beginning on hand (BOH) 262, which indicates that the inventory has to be on hand at the beginning of a day or that a customer can expect the shipment at the beginning of a day. An alternative inventory model may be ending on hand model (EOH) 264 that indicates that the inventory has to be on hand at the end of a previous day or that a customer does not receive the shipment until the end of the customer's day.

Referring again to FIG. 1, when the supply line information 125 is ready to be used (e.g., properly entered and stored), the customer business analyst 110 may activate the supply line management mechanism 130 whenever the need for recommendation arises. The activation 165 may be indicated through a communication interface between the customer business analyst 110 and the supply line management mechanism 130. For instance, such an interface may be a web interface or a proprietary application GUI interface. The activation 165 may be sent to the supply line management mechanism through a network (e.g., if the supply line management mechanism 130 is installed in a different computer system), such as a local area network (LAN), a wide area network (WAN), the Internet, a wireless network, or a proprietary network.

Upon being activated, the supply line management mechanism 130 utilizes the supply line information 125 to make inventory recommendations to the customer business analyst 110 (or to the customer directly through the web) to ensure that customers' needs are promptly satisfied. A recommendation may include projected information regarding when to ship what product to which customer sites. To reduce cost, the supply line management mechanism 130 attempts to generate such recommendations in a most efficient manner, measured, for example, based on number of recommendations. To do so, the inventory projection mechanism 150 in the supply line management mechanism 130 may first produce an inventory projection 155 according to the supply line information 125 (e.g., specific production schedules). Such inventory projection may indicate the inventory quantity that is needed (on each day or during a period of time) to ensure that the underlying production line is supplied with necessary materials for scheduled production activities.

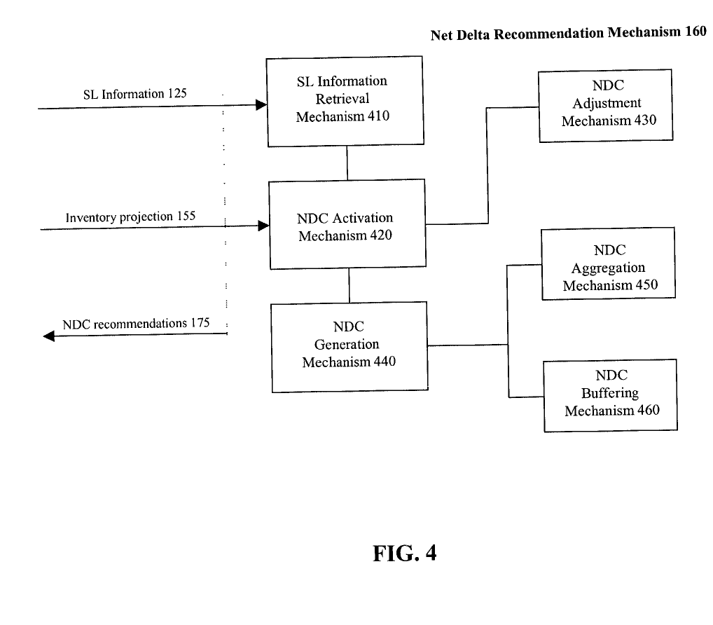

Once the inventory projection 155 is generated, the net delta recommendation mechanism 160 further processes the inventory projection 155 to generate recommendations that meet various delivery targets and goals. Necessary aggregation of individual recommendations ma be performed and recommendation buffering may also be performed to minimize the number of recommendations generated. Details about the net delta recommendation mechanism 160 is discussed in referring to FIGS. 4-14.

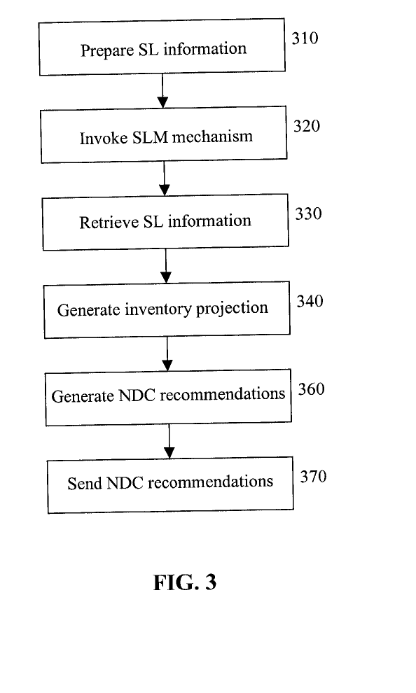

FIG. 3 is an exemplary flowchart of a process, in which the supply line management system 100 provides inventory net delta recommendations to the customer business analyst 110 based on the supply line information 125, according to embodiments of the present invention. The supply line information 125 is first prepared at act 310. The customer business analyst 110 then invokes, at act 320, the supply line management mechanism 130 for recommendations. The supply line management mechanism 130 retrieves, at act 330, the supply information 125 necessary for generating the requested recommendation. The inventory projection 155 is first generated at act 340. Based on both the supply line information 125 and the inventory projection 155, the net delta recommendation mechanism 160 generates, at act 350, the net delta recommendations 175, which is then sent to the customer business analyst 110.

FIG. 4 depicts the internal high level functional block diagram of the net delta recommendation mechanism 160, according to embodiments of the present invention. The net delta recommendation mechanism 160 includes a supply line information retrieval mechanism 410, an NDC activation mechanism 420, an NDC adjustment mechanism 430, an NDC generation mechanism 440, an NDC aggregation mechanism 450, and an NDC buffering mechanism 460. Upon being invoked by the customer business analyst 110, the supply line information retrieval mechanism 410 retrieves the supply line information 125 from the supply line information storage 140 and then passes on the information to the NDC activation mechanism 420.

The NDC activation mechanism 420 takes the supply line information 125 and the inventory projection 155 as input and determines the strategy of generating the NDC recommendations according to the specific conditions during a time period under which the NDC recommendation is requested. For example, if there is a particular inventory target during the time period with a specific inventory quantity to be satisfied on a specific day, the NDC activation mechanism 420 may invoke the NDC adjustment mechanism 430 to generate NDC recommendations that makes sure that the particular inventory target is met.

As discussed earlier, a customer may specify, together with other types of supply line information, the minimum goal or maximum goal for their inventory. In this case, a customer may define the minimum goal as the smallest and the maximum goal as the largest inventory quantity. Such goals may be specified on a daily basis. For example, the lowest inventory quantity on each day may not be lower than 4 units (minimum goal) and the highest inventory quantity on each of such days may not exceed 8 units (maximum goal). That is, the minimum and maximum goals provide constraints (lower bound and upper bound) on the inventory quantity for, for instance, cost or efficiency reasons.

The inventory projection 155 may be generated based on production needs. For example, needed inventory quantity may be estimated to make sure that the supply is adequate or plentiful for production. Such projection may not consider other factors such as inventory cost and efficiency. For instance, any amount of projected inventory that exceeds the need of production guarantees that the supply is adequate. Yet, such a projection may not lead to efficient or low inventory cost. The minimum and maximum goals provide constraints (lower and upper bounds) for the inventory projection. When the inventory projection 155 is within the bounds specified by the minimum goal and the maximum goal, the underlying inventory projection 155 may be used directly as the recommendation and no net delta change may be required. When the inventory projection 155 leads to an excursion with respect to either a minimum goal or a maximum goal, the NDC activation mechanism 420 invokes the NDC generation mechanism 440 to revise the inventory projection 155 and to generate NDC recommendations with minimized excursions with respect to given minimum and maximum constraints.

Upon being activated, the NDC generation mechanism 440 handles detected excursion, which may include violation of either minimum goals or maximum goals. An appropriate time period (or a calculation window) may be defined by the NDC generation mechanism 440. For example, such an appropriate window may correspond to a period starting with a valid receiving day (of inventory) and ending with the next valid receiving day. Such valid receiving days may be defined in consideration of weekends, holidays, or other special event days that are relevant to the production schedule of a customer. Furthermore, the boundary of an appropriate time period may also shift near the boundary depending on the condition of the processing. For example, depending on the inventory model used (e.g., beginning on hand model 262 and ending on hand model 264 in FIG. 2), the boundary of a calculation window may shift one day in accordance with the model used. In general, an appropriate time period applicable to the NDC generation mechanism 440 is determined according to particular application requirements.

The processing by the NDC generation mechanism 440 may be performed within an above mentioned appropriate time period. The excursions are being handled with respect to the time period. The NDC generation mechanism 440 removes, if possible, any excursion within the time period through revising underlying inventory projections using net delta changes. The NDC generation mechanism 440 may create new or revise existing net delta changes (NDCs) according to excursion conditions. The updated NDCs may then be used to re-project the inventory to generate updated inventory projection by incorporating updated NDCs to the original inventory projection over the time period. For example, if a violation to the minimum goal on a particular day of the time period is detected, a positive NDC may be created or updated (if already exists) to be added to the inventory projection for that particular day.

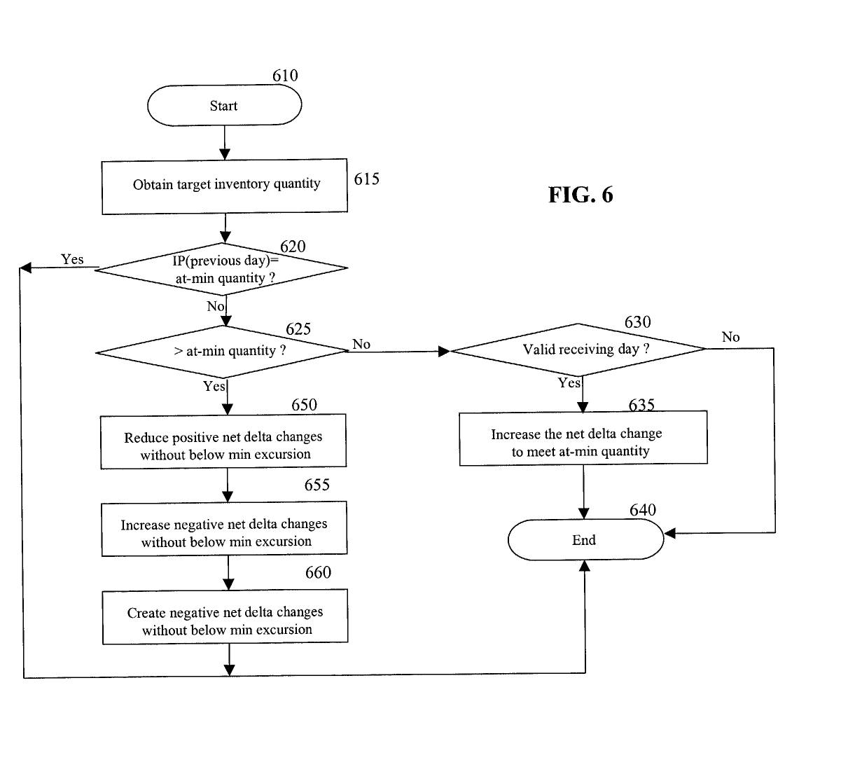

To minimize the number of NDC recommendations, the NDC generation mechanism 440 invokes the NDC aggregation mechanism 450, which consolidates different NDCs, and the NDC buffering mechanism 460, which buffers different NDC recommendations whenever possible. Aggregation may be performed when similar type of inventory excursions are detected in a processing period so that inventory changes made to remove excursions can be consolidated on a single day, provided that it does not cause further excursions as a result of the aggregation from the day of the aggregation to the end of the aggregation window. Buffering NDCs aims at proactively reducing future possible excursions. It may be achieved by removing inventory positions as far away from both the minimum and the maximum goals as possible. Detailed operational details about the NDC activation mechanism 420, the NDC adjustment mechanism 430, the NDC generation mechanism 440, the NDC aggregation mechanism 450, and the NDC buffering mechanism 460 are discussed below in referring to FIG. 6 to FIG. 14.

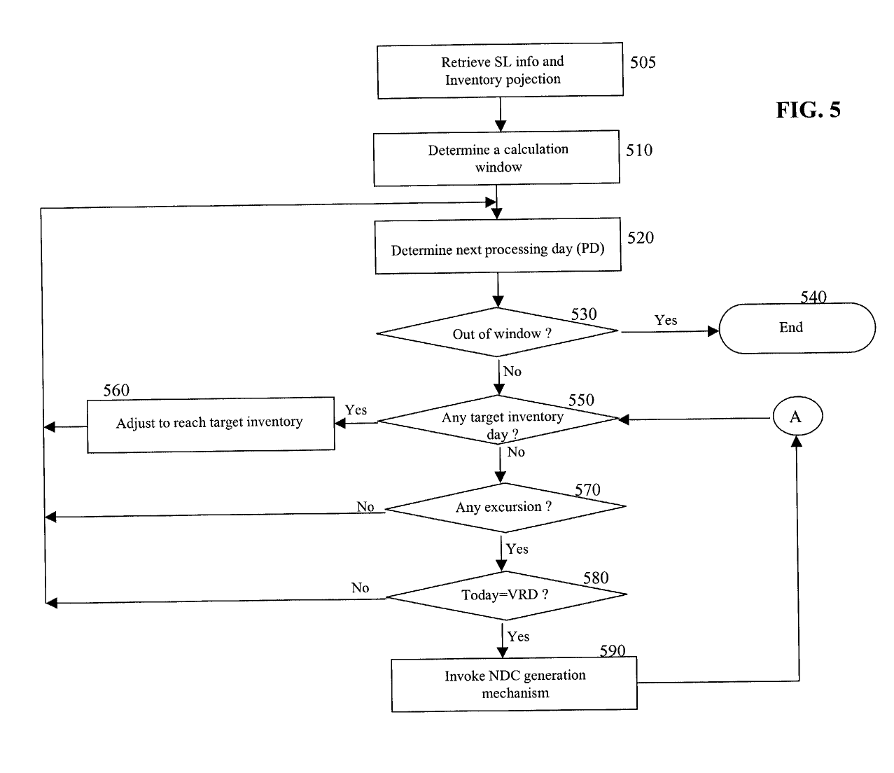

FIG. 5 is an exemplary flowchart of a process, in which the net delta recommendation mechanism 160 generates the net delta recommendations 175, according to embodiments of the present invention. Upon being invoked by the customer business analyst 110, the supply line information is first retrieved, at act 505. Such retrieved supply line information may include, but not limited to, any information illustrated in FIG. 2. For example, minimum and maximum goals may be retrieved to facilitate the detection of excursions. Other relevant supply line information may also be retrieved to, for example, determine an appropriate calculation window. Inventory data such as inventory backlog may also be obtained so that net delta changes may be generated in considering of all the inventory that may be potentially available.

Based on retrieved supply line information 125, an appropriate calculation window is determined at act 510. Since net delta recommendations 175 are generated with respect to a time period (the calculation window), which may consist of a plurality of days, the net delta recommendation mechanism 160 may proceed its processing for each single day at a time. Within the calculation window, a next processing day is determined at act 520. The next processing day may or may not correspond to the calendar next day. If the next processing is out of the calculation window, the processing terminates at act 540.

If next processing day is within the calculation window and if there is a specified target on that day, determined at act 550, the net delta recommendation mechanism 160 invokes, at act 560, the NDC adjustment mechanism 430 to meet the specified target. After the NDC adjustment mechanism 430 adjusts the NDCs to satisfy the target, the processing returns to act 520 to proceed to the next day. When there is no specified target, the net delta recommendation mechanism 160 further determines, at act 570, whether there is any excursion with respect to minimum and maximum goals. If there is any excursion, the net delta recommendation mechanism 160 invokes, at act 580, the NDC generation mechanism 440 to minimize or to remove the detected excursion within the calculation window.

FIG. 6 is an exemplary flowchart of a process, in which the NDC adjustment mechanism 430 updates NDCs to meet a particular inventory target, according to an embodiment of the present invention. An inventory target is first obtained at act 610. This quantity may indicate a required (e.g., strictly observed) inventory quantity on next day. To meet the requirement, the NDC adjustment mechanism 430 first determines, at act 620, whether the requirement is already satisfied. If the inventory projection on previous day is at the desired quantity (e.g., the desired quantity may be the minimum quantity), there is no adjustment is needed. In this case, the processing terminates at act 640. In the exemplary embodiment illustrated in FIG. 6, the target quantity is the minimum goal. In general, the target quantity can be any desired quantity.

If the inventory projection does not meet the desired quantity, the NDC adjustment mechanism 430 proceeds to determine, at act 625, whether the inventory projection of the day prior to the target inventory goal is lower than or higher than the desired target quantity. If the inventory on the day prior to the target inventory goal is lower than the desired quantity and the current processing day is a valid receiving day, determined at acts 625 and 630, the NDC adjustment mechanism 430 increases the NDC of that day, at act 635, to meet the target. If the inventory on the day prior to the target inventory goal is higher than the target quantity, the NDC adjustment mechanism 430 needs to decrease NDCs to meet the target. Since decreasing NDCs may led to violation of minimum goals, the NDC adjustment mechanism 430 tries to meet the target by attempting different acts, each of which is constrained by the criterion of not creating a below minimum goal excursion.

To meet the target quantity (minimum goal quantity) based on a current inventory exceeding the target, the NDC adjustment mechanism 430 reduces, at act 650, any existing positive NDCs in the calculation window prior to the target day in such a manner that no below minimum goal excursion occurs. If, after the adjustment performed at act 650, the inventory is still over the minimum goal quantity, the NDC adjustment mechanism 430 increases, at act 655, the existing negative NDCs to further cut the inventory. For example, if an existing negative NDC is −2, the NDC adjustment mechanism 430 may increase this negative value to −4. If the revision to the negative NDCs still does not reach the target quantity, the NDC adjustment mechanism 430 may further creates, at act 660, new NDCs (e.g., negative NDCs) to reduce the inventory.

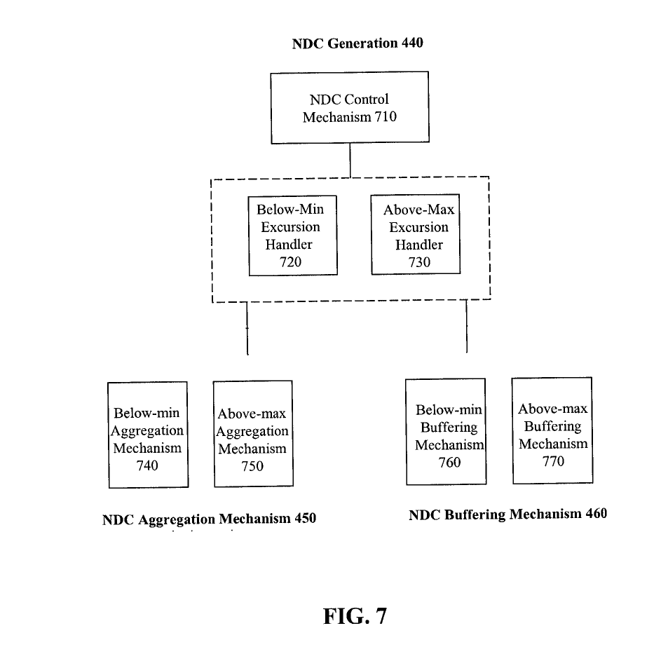

When there is an excursion, the net delta recommendation mechanism 160 invokes the NDC generation mechanism 440 to remove or to minimize the excursion. Depending on the type of excursion, the NDC generation mechanism 440 may act differently. In addition, the updated NDCs, generated to remove excursions, may be aggregated and buffered for efficiency reasons (to minimize the number of NDC recommendations). FIG. 7 depicts the internal structure of the NDC generation mechanism 440 and its relationships with the NDC aggregation mechanism 450 and the NDC buffering mechanism 460, according to an embodiment of the present invention.

The NDC generation mechanism 440 comprises a NDC control mechanism 710, a below minimum excursion handler 720, and an above maximum excursion handler 730. The NDC control mechanism 710 determines the type of excursion and directs the processing to appropriate mechanisms. Specifically, when there is a below minimum excursion (i.e., current inventory projection is lower than a pre-defined minimum goal), the NDC control mechanism 710 invokes the below minimum excursion handler 720 to remove or to minimize the excursion. When there is an above maximum excursion (i.e., current inventory projection is higher than a pre-defined maximum goal), the NDC control mechanism 710 invokes the NDC above maximum excursion handler 730 to remove or to minimize the excursion.

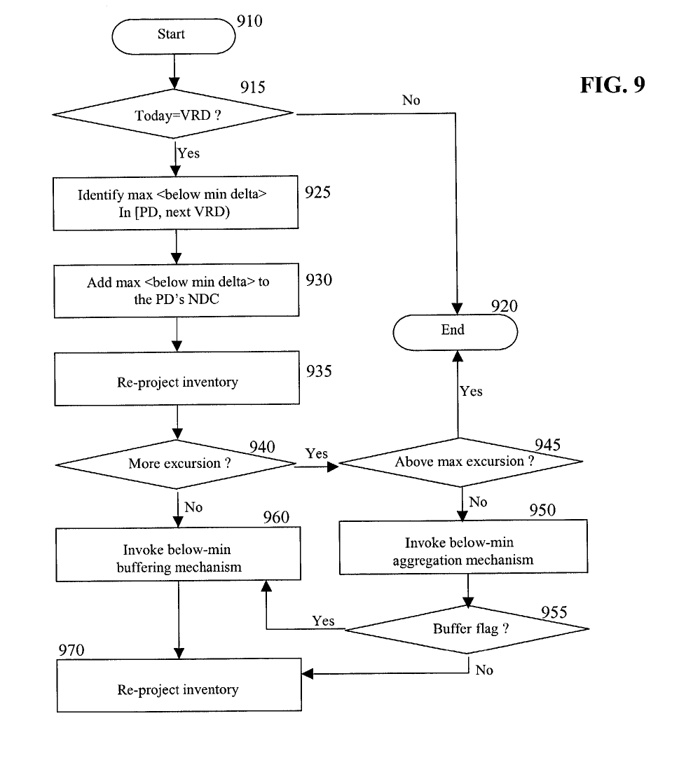

Upon being invoked when a below minimum excursion is detected, the below minimum excursion handler 720 updates existing NDCs and re-projects the inventory so that the detected below minimum excursion is minimized and results in updated NDC recommendations 175. To reduce the number of NDC recommendations to minimal (e.g., for efficiency), the below minimum excursion handler 720 may invoke NDC aggregation mechanism 450 to consolidate the NDCs and the NDC buffering mechanism 460 to generate buffer space to reduce future possible excursions. The details about the below minimum excursion handler 720 is discussed in referring to FIG. 9.

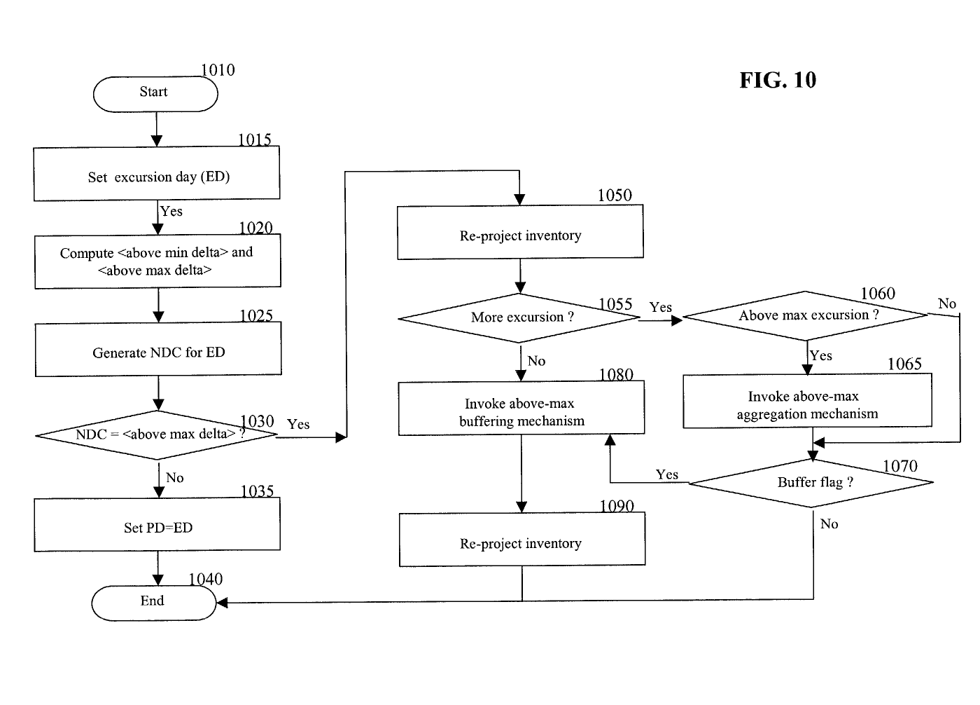

Similarly, upon being invoked when an above maximum excursion is detected, the above maximum excursion handler 730 updates existing NDCs so that the detected bove maximum excursion is minimized. Such processing may generate updated NDC recommendations 175. To reduce the number of NDC recommendations to minimal (e.g., for efficiency), the above maximum excursion handler 730 may invoke both NDC aggregation mechanism 450 to consolidate NDCs and the NDC buffering mechanism 460 to generate buffer space so that future possible excursions can be minimized. The details about the above maximum excursion handler 730 is discussed in referring to FIG. 10.

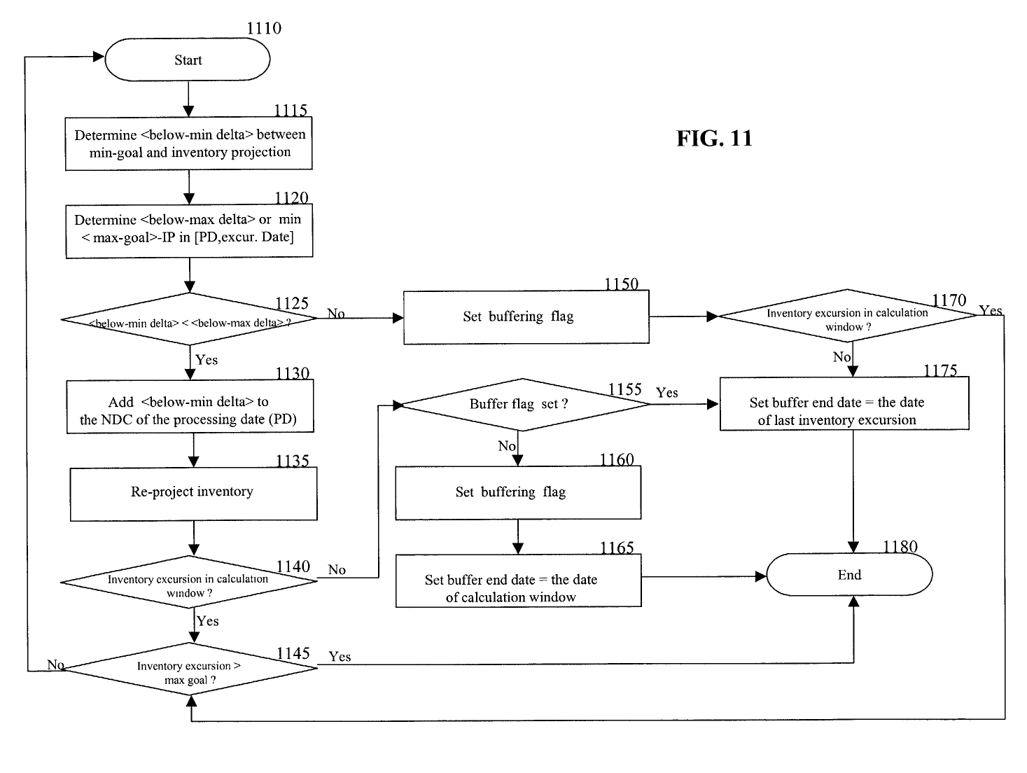

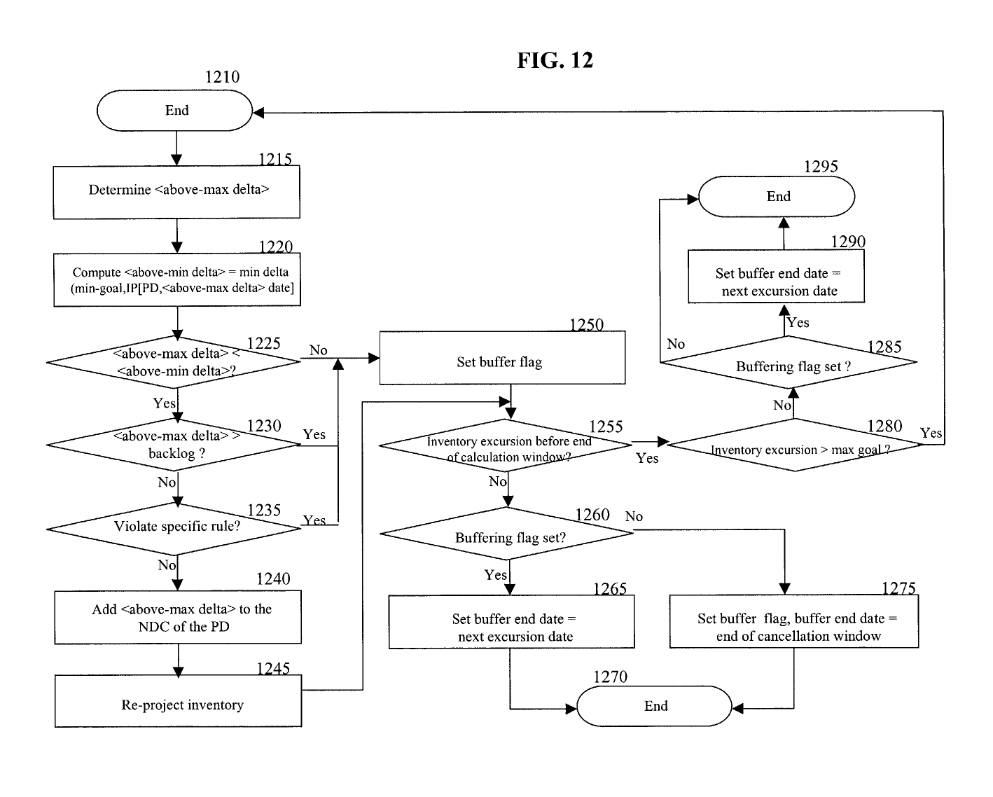

The NDC aggregation mechanism 450 includes a below minimum aggregation mechanism 740, which is responsible for aggregating NDCs updated by the below minimum excursion handler 720, and an above maximum aggregation mechanism 750, which is responsible for aggregating NDCs updated by the above maximum excursion handler 730. The details about how the aggregation takes place is described in referring to FIGS. 11 and 12.

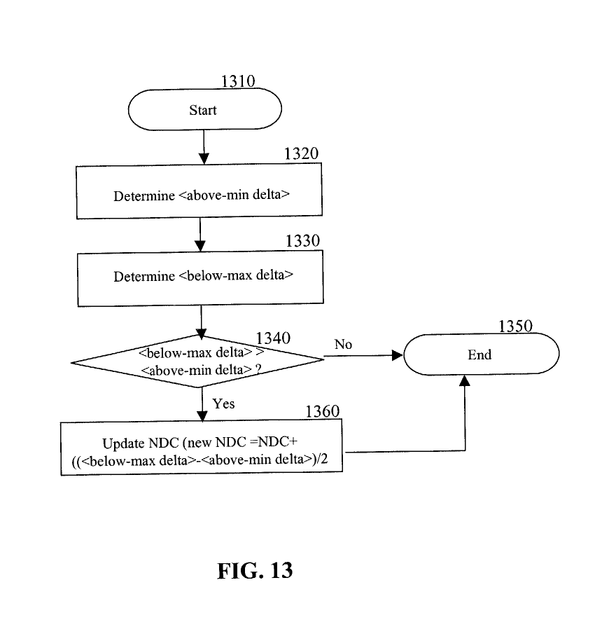

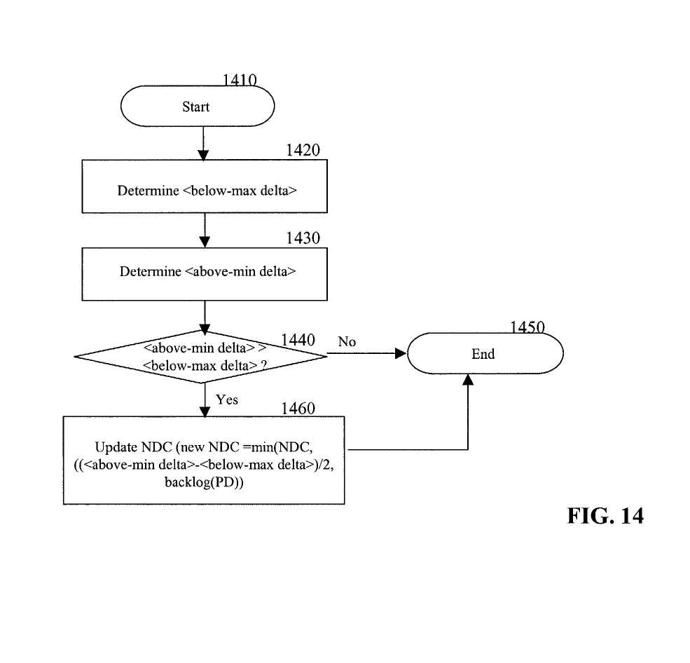

The NDC buffering mechanism 460 includes a below minimum buffering mechanism 740, which is responsible for buffering NDCs updated by the below minimum excursion handler 720, and an above maximum buffering mechanism 750, which is responsible for buffering NDCs updated by the above maximum excursion handler 730. The details about how the buffering takes place is described in referring to FIGS. 13 and 14.

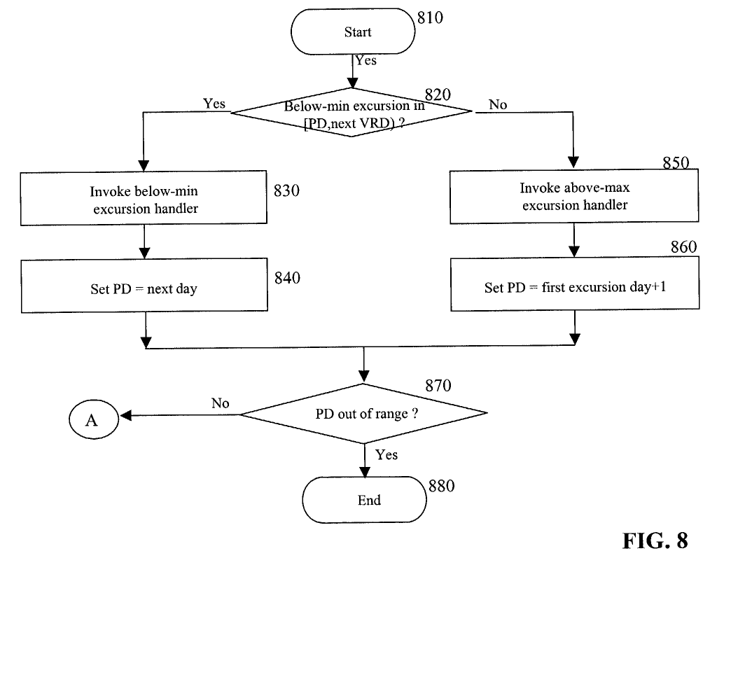

FIG. 8 is an exemplary flowchart of a process, in which the NDC control mechanism 710 determines the type of an excursion and appropriately directs the processing based on excursion condition, according to an embodiment of the present invention. The excursion type is first determined at act 820. If the excursion type is below minimum, the NDC control mechanism 710 invokes, at act 830, the below minimum excursion handler 720. Upon returning from the below minimum excursion handler 720, the NDC control mechanism 710 sets, at act 840, the current processing day as the next day in the calculation window. If the excursion is of above maximum type and processing day (today) is a valid receiving day (VRD), determined at 850, the NDC control mechanism 710 invokes, at act 860, the above maximum excursion handler 730. Upon returning from the above maximum excursion handler 730, the NDC control mechanism 710 sets, at act 870, the current processing day as the day after the first excursion day in the calculation window. If the current processing day (set at either act 840 or act 870) is not out of calculation window, determined at act 880, the NDC control mechanism 710 returns the processing from the NDC generation mechanism 440 back to the NDC activation mechanism 420 (see FIG. 5). If the current processing day (today) is not a valid receiving day, the processing terminates at act 890.

FIG. 9 is an exemplary flowchart of a process, in which the below minimum excursion handler 720 minimizes a below minimum excursion, according to an embodiment of the present invention. The goal of the below minimum excursion handler 720 is to reduce the excursion as much as it can within an appropriate period by adding certain amount of net delta changes (NDC) on one or more proper days in the appropriate period. Such an appropriate period may be defined, for example, as between the current processing day to the day prior to the net valid receiving day. The below minimum excursion handler 720 first, at act 925, identifies, if it is a valid receiving day (determined at act 915), a quantity called below minimum delta or excursion amount within the appropriate period. The below minimum delta may be calculated as the largest difference between the inventory projection and the minimum goal within the appropriate period.

The below minimum delta is then added, at act 930, to the NDC of the current processing day to generate an updated NDC. Based on this updated NDC on the processing day, the inventory is re-projected, at act 935, to generate updated inventory projection. If the updated inventory projection causes no further excursion, determined at act 940, the below minimum excursion handler 720 invokes, at act 960, the below minimum buffering mechanism 760 to buffer updated NDCs.

If further excursion exists, it may correspond to either a below minimum excursion or an above maximum excursion. If further excursion is an above maximum type, the processing returns from the NDC generation mechanism 440 back to the NDC control mechanism 710 from where the processing may be directed to the above maximum excursion handler 730 (see FIG. 7). If the further excursion is of below minimum type, the below minimum aggregation mechanism 740 is invoked, at act 950, to aggregate NDCs to remove the excursions. Based on the aggregation results, the NDCs may be further updated through buffering. This is achieved at act 960 by invoking the below minimum buffering mechanism 760. Based on the NDCs generated by the buffering process, the below minimum excursion handler 720 then re-projects, at act 970, the inventory projection.

FIG. 10 is an exemplary flowchart of a process, in which the above maximum excursion handler 730 minimizes an above maximum excursion, according to an embodiment of the present invention. The goal of the above maximum excursion handler 730 is to reduce the excursion as much as it can within an appropriate period creating negative net delta changes (NDCs) on one or more proper days in the appropriate period. Such an appropriate period may be defined, for example, in a similar fashion as what is employed by the below minimum excursion handler 720 (i.e., a period between the current processing day to the day prior to the net valid receiving day). The appropriateness defined in handling above maximum excursion may differ from what is defined in handling below minimum excursion. In general, it is determined according to specific application needs. The above maximum excursion handler 730 first, at act 1015, sets the current processing day as the day on which the above maximum excursion is detected. Two quantities, one is an above maximum delta and the other is above minimum delta, are computed, at act 1020. The former may be calculated as the amount of above maximum excursion and the latter is the smallest difference between the inventory projection and the minimum goal within the previous defined appropriate period.

To remove an above maximum excursion, the above maximum excursion handler 730 generates, at act 1025, an NDC for the excursion day. The generated NDC may be computed as the smallest of three values: the above maximum delta, the above minimum delta, and the amount of inventory backlog. The generated NDC may be subject to certain managing rules. For example, a particular application may require that daily net delta changes may not exceed certain amount. The generated NDC is then used to determine how the excursion may be handled. If the generated NDC is not equal to the above maximum delta, determined at act 1030, it indicates that the above maximum excursion detected can not be completely removed. In this case, the above maximum excursion handler 730 does not implement partial removal. Instead, it sets, at act 1035, the processing day as the excursion day and terminates the processing at act 1040.

If the generated NDC is equal to the above maximum delta (i.e., the above maximum excursion can be completely removed), the above maximum excursion handler 730 re-projects, at act 1050, the inventory based on the generated NDC to generate updated inventory projection. If there is no more excursion, determined at act 1055, the above maximum excursion handler 730 invokes, at act 1080, the above maximum buffering mechanism 770 to buffer the generated NDCs.

If further excursion exists and it corresponds to an above maximum type, determined at act 1060, the above maximum aggregation mechanism 750 is invoked, at act 1065, to aggregate the NDCs to remove the excursion. Based on the aggregation results, the above maximum excursion handler 730 invokes, at act 1080, the above maximum buffering mechanism to buffer the NDCs. Using the buffered NDCs, the above maximum excursion handler 730 then re-projects, at act 1090, the inventory projection.

FIG. 11 is an exemplary flowchart of a process, in which the below minimum aggregation mechanism 740 aggregates NDCs when a further below minimum excursion condition is detected, according to an embodiment of the present invention. To remove further below minimum excursion, NDCs are aggregated. To do so, a below minimum delta or the excursion amount is first computed, at act 1115, as the difference between the minimum goal and the inventory projection. A below maximum delta is then computed, at act 1120, as the smallest difference between the maximum goal and the inventory projection within an appropriate period. Such an appropriate period may be determined as, for example, between the current processing day and the day on which the excursion is detected.

If the below minimum delta has a quantity smaller than that of the below maximum delta, determined at act 1125, aggregation is performed. In this case, the below minimum delta is added, at act 1130, to the NDC of the processing day to generated an updated NDC. The inventory is then re-projected, at act 1135, based on the updated NDC. If the updated inventory projection leads to further above maximum excursion, determined at acts 1140 and 1145, the processing terminates at act 1180. If the updated inventory projection leads to further below minimum excursion, the process of below minimum aggregation is repeated starting at act 1110.

If the updated inventory projection leads to no further excursion, determined at act 1140, the below minimum aggregation mechanism 740 sets up, prior to terminating its processing at act 1180, parameters that are necessary for buffering purposes, which may includes setting up a buffer flag or an appropriate buffer period. In the exemplary embodiment illustrated in FIG. 11, if a buffer flag is not yet set, determined at act 1155, the below minimum aggregation mechanism 740 sets, at acts 1160 and 1165, the buffer flag and the buffer end date to be the end of the calculation window. If the buffer flag has been set, the below minimum aggregation mechanism 740 sets, at act 1175, the buffer end date to be the date on which a previous inventory excursion is detected.

If the below minimum delta is larger than the below maximum delta, determined at act 1125 (i.e., only partial excursion removal is possible), the below minimum aggregation mechanism 740 may not implement partial removal. In this case, it sets the buffer flag at act 1150 and then determines, at act 1170, whether there is an excursion within the calculation window. If there is no other excursion, the below minimum aggregation mechanism 740 sets, prior to terminating its processing at act 1180, the buffer end date to be the date on which a previous inventory excursion is detected. If more below minimum excursion exists, determined at act 1170 and 1145, the below minimum aggregation is repeated starting from act 1110.

FIG. 12 is an exemplary flowchart of a process, in which the above maximum aggregation mechanism 750 aggregates NDCs when a further above maximum excursion condition is detected, according to an embodiment of the present invention. To remove further above maximum excursion, NDCs are aggregated. To do so, the excursion amount o above maximum delta is first determined, at act 1215, as the difference between the minimum goal and the inventory projection. An above minimum delta is then computed, at act 1220, as the smallest difference between the minimum goal and the inventory projection within an appropriate period. Such an appropriate period may be determined as, for example, between the current processing day and the excursion day.

Based on the excursion amount and the above minimum delta, the above maximum aggregation mechanism 750 then determines whether the excursion can be removed via aggregation. If the excursion amount (above maximum delta) is smaller than the above minimum delta and larger than the inventory backlog and does not violate certain rules employed in the system (e.g., daily cumulative NDC has to be greater than zero within a certain range), determined at acts 1225, 1230 1235, the excursion can be removed completely. In this case, the above maximum aggregation mechanism 750 adds, at act 1240, the excursion amount to the NDC of the processing day. The aggregation generates an updated NDC, based on which the inventory is re-projected at act 1245.

If further above maximum excursion exists within the calculation window, determined at acts 1255 and 1280, the above maximum aggregation mechanism 750 repeats the aggregation process starting at act 1210. If further below minimum excursion exists, the above maximum aggregation mechanism 750 either sets buffer end date, if a buffer flag has been set, to be the next excursion date or terminates, if there is no buffer flag set, its processing at act 1295.

If there is no further excursion in the calculation window, determined at act 1255, the above maximum aggregation mechanism 750 sets up, prior to terminating the processing at act 1270, parameters that are necessary for buffering purposes, which may includes setting up a buffer flag or an appropriate buffer period. In the exemplary embodiment illustrated in FIG. 12, if a buffer flag is not yet set, determined at act 1260, the above maximum aggregation mechanism 750 sets, at acts 1275, the buffer flag and the buffer end date to be the end of the calculation window. If the buffer flag has been set, the above maximum aggregation mechanism 750 sets, at act 1265, the buffer end date to be the date on which the next inventory excursion is detected.

If the excursion amount (above maximum delta) is larger than the above minimum delta, determined at act 1225, only partial excursion removal is possible. In this case, the above maximum aggregation mechanism 750 does not perform removal. Instead, it sets the buffer flag at act 1250. It then determines, at acts 1255 and 1280, whether there is an excursion within the calculation window. If there is no other excursion, the above maximum aggregation mechanism 750 sets the buffer flag and the buffer end date according to the same criteria described earlier (acts 1260, 1265, and 1275). If an above maximum excursion exists, determined at act 1280, the above maximum aggregation process is repeated starting from act 1210. If a below minimum excursion exists in the calculation window, the above maximum aggregation mechanism 750 determines, at act 1285, whether a buffer flag has already been set. If the buffer flag has been set, the above maximum aggregation mechanism 750 sets, at act 1290, appropriate buffer end date to be the next excursion date. Otherwise, the processing terminates at act 1295.

After NDCs are aggregated, buffering mechanism is invoked to generate buffer space for NDCs to minimize future possible excursions. As discussed earlier, buffering NDCs is designed to proactively reduce future possible excursions. It may be achieved by removing inventory projections as far away from both the minimum and the maximum goals as possible. When an excursion occurs, there may be many different alternatives to remove the excursion. For example, if a below minimum excursion occurs, it may be removed by increasing the NDC on the excursion day by the excursion amount (assuming it does not violate other rules). This may create a marginal situation, though. That is, the cure to the current excursion may be very sensitive to any future changes or another slight change may cause another excursion. One alternative, therefore, to the marginal cure to the below minimum excursion may be to increase the NDC by an amount larger than the excursion amount (such larger amount may be subject to other restrictions such as maximum goal). The difference between the excursion amount and the larger amount is called buffer. The NDC buffering mechanism 460 (see FIG. 7) facilitates the function of creating buffer for NDCs.

Buffering NDCs under different excursion conditions may be dealt with separately. As depicted in FIG. 7, the below minimum buffering mechanism 760 buffers NDCs when a below minimum excursion is detected and the above maximum buffering mechanism 770 buffers NDCs when an above maximum excursion is detected. Both buffering mechanisms 760 and 770 may process based on various factors. For example, both minimum and maximum goals may have to be considered simultaneously. In addition, the buffering strategy may subject to other rules employed in a particular application system.

FIG. 13 is an exemplary flowchart of a process, in which the below minimum buffering mechanism 760 buffers NDCs under a below minimum excursion condition, according to an embodiment of the present invention. The below minimum buffering mechanism 760 first determines, at act 1320, an above minimum delta as the difference between inventory projection and the minimum goal. It then determines, at act 1330, a below maximum delta as the difference between inventory projection and the maximum goal. These two quantities, the above minimum delta and the below maximum delta, represent the distances of the inventory from its allowed bounds specified by the minimum and maximum goals. In the illustrated embodiment in FIG. 13, if the distance between the inventory and the maximum goal (below maximum delta) is no greater than the distance between the inventory and the minimum goal, determined at act 1340, the below minimum buffering mechanism 760 does not attempt to change the current NDC. In this case, the processing terminates at act 1350. Otherwise, the below minimum buffering mechanism updates, at act 1360, the current NDC. To increase the buffer with respect to the minimum goal, the current NDC is to be increased (to be away from the minimum goal). For example, a buffer value may be computed as one half of the distance between the below maximum delta and the above minimum delta and such a buffer value is then added to the existing NDC.

It should be appreciated by one skilled in the art that other alternative update strategies may also be employed in terms of how NDCs can be changed to create an appropriate buffer. For example, the below minimum buffering mechanism 760 may use a different criterion to determine whether buffering should be performed. In addition, different methods of computing the buffer space may also be used.

FIG. 14 is an exemplary flowchart of a process, in which the above maximum buffering mechanism 770 buffers NDCs under an above maximum excursion condition, according to an embodiment of the present invention. The above maximum buffering mechanism 770 first determines, at act 1420, the above minimum delta as the difference between inventory projection and the minimum goal. It then determines, at act 1330, the below maximum delta as the difference between inventory projection and the maximum goal. These two computed differences, the above minimum delta and the below maximum delta represent the distances of the inventory from its allowed bounds specified by the minimum and maximum goals. If the distance between the inventory and the minimum goal (above maximum delta) is no greater than the distance between the inventory and the maximum goal, determined at act 1440, the above maximum buffering mechanism 770 does not attempt to change the current NDC. In this case, the processing terminates at act 1450. Otherwise, the above maximum buffering mechanism 770 updates, at act 1460, the current NDC. To increase the buffer with respect to the maximum goal, the existing NDC value may be decreased (move away from the maximum goal). For instance, the decreasing amount may be computed as the minimum value of the following three quantities: the current NDC, one half of the distance between the below maximum delta and the above minimum delta, and the inventory backlog. Such determined quantity is then used to replace the current NDC.

It should be appreciated by one skilled in the art that other alternative NDC update strategies may be employed. For example, the above maximum buffering mechanism 770 may employ an alternative criterion to determine when buffering should be performed. In addition, different computations may be applied to estimate the updated NDC.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method for supply line management, comprising:
generating an inventory projection based on supply line information;
generating a net delta change recommendation based on the supply line information and the inventory projection.

2. The method according to claim 1, further comprising:
preparing the supply line information prior to said generating the inventory projection.

3. A method for generating a net delta change recommendation, comprising:
accessing supply line information and an inventory projection generated based on the supply line information;
determining an appropriate calculation window;
adjusting, if there is a target inventory during a period within the calculation window, by an net delta change adjustment mechanism, the inventory projection to meet the target inventory; and
generating, if there is either a below minimum inventory excursion, with respect to a minimum goal, or an above maximum inventory excursion, with respect to a maximum goal, by an net delta change generation mechanism, an net delta recommendation to remove the excursion.

4. The method according to claim 3, wherein the supply line information includes at least some of:
inventory data;
an inventory goal; and
an inventory model.

5. The method according to claim 4, wherein
the inventory data includes at least some of:
inventory forecast,
inventory backlog, and
inventory transit;
the inventory goal includes at least one of:
a minimum goal comprising at least a minimum inventory quantity,
a maximum goal comprising at least a maximum inventory quantity, and
an inventory target comprising at least a target inventory quantity and a target date; and
the inventory model includes at least one of:
a beginning on hand model indicating inventory on hand at beginning of a day, and
an ending on hand model indicating inventory on hand at ending of a day.

6. The method according to claim 5, wherein said adjusting the inventory projection comprises:
obtaining the target inventory quantity of an inventory target from the supply line information;
increasing, if the inventory projection on the day prior to the target date of the inventory target is lower than the target inventory quantity, the net delta change of the current valid receiving day to meet the target inventory; and
decreasing, if the inventory projection on the day prior to the target date of the inventory target is higher than the target inventory quantity, the net delta changes in an appropriate period within the calculation winow through at least one of:
reducing positive net delta changes in the appropriate period without causing a below minimum excursion,
increasing negative net delta changes in the appropriate period without causing the below minimum excursion, and
creating negative net delta changes in the appropriate period without causing the below minimum excursion.

7. The method according to claim 4, wherein said generating a net delta recommendation comprises:
determining the excursion type as either below minimum excursion or above maximum excursion;
handling, by a below minimum excursion handler, below minimum excurion, if the below minimum excursion is determined; and
handling, by a above maximum excursion handler, above maximum excursion, if the above maximum excursion is determined.

8. The method according to claim 7, wherein said handling below minimum excursion comprises:
identifying the maximum below minimum delta within an appropriate period;
adding the maximum below minimum delta to the net delta change to generate an updated net delta change;
projecting inventory based on the updated net delta change to generate an updated invenory projection;
determining, based on the updated inventory projection, whether there is still an excursion and the corresponding excursion date;
performing below minimum aggregation, if a below minimum excursion is determined;
performing below minimum buffering; and
projecting inventory based on the results from the below minimum aggregation and the below minimum buffering.

9. The method according to claim 8, wherein
said performing below minimum aggregation comprises:
determining a below minimum delta as the difference between a minimum goal and the updated inventory projection on the excursion date,
computing a below maximum delta as the minimum difference between a maximum goal and the updated inventory projection in an appropriate period,
adding, if the below minimum delta is greater than the below maximum delta, the below minimum delta to the net delta change,
projecting inventory, based on the updated net delta change, to produce a new updated inventory projection,
determining whether there is an inventory excursion and the corresonding inventory excursion date,
setting an appropriate buffer end date if the inventory excursion does not exist, and
repeating the below minimum aggregation if the inventory excursion is smaller than the maximum goal; and
said performing below minimum buffering comprises:
determining an above minimum delta as the smallest difference between the new updated inventory projection and the minimum goal in an appropriate period,
determining a below maximum delta as the smallest difference between the new update inventory projection and the maximum goal in the appropriate period, and
updating, if the below maximum delta is greater than the above minimum delta, the net delta change based on the difference between the below maximum delta and the above minimum delta.

10. The method according to claim 7, wherein said handling above maximum excursion comprises:
computing an above minimum delta and an above maximum delta;
generating an net delta change for the excursion date based on the smallest value of the above minimum delta, the above maximum delta, and the inventory backlog;
determining whether the net delta change, generated by the generating, is equal to the above maximum delta;
projecting inventory based on the net delta change, generated by the generating, if the net delta change is equal to the above maximum delta, to generate an updated inventory projection;
determining, based on the updated inventory projection, whether there is still an excursion and its corresponding excursion date;
performing above maximum aggregation, if an above maximum excursion is determined;
performing above maximum buffering; and
projecting inventory based on the results from the above maximum aggregation and the above maximum buffering.

11. The method according to claim 10, wherein
said performing above maximum aggregation comprises:
determining an above maximum delta as the difference between the maximum goal and the updated inventory projection on the excursion date,
computing an above minimum delta as the minimum difference between the minimal goal and the updated inventory projection in an appropriate period within the calculation window,
adding, if the above maximum delta is lower than the above minimum delta and the above maximum delta is lower than the inventory backlog, the above maximum delta to the net delta change to generate an updated net delta change,
projecting inventory, based on the updated net delta change, to produce a new updated inventory projection,
determining whether there is an inventory excursion and the corresonding inventory excursion date,
setting an appropriate buffer end date if the inventory excursion does not exceed the maximum goal, and
repeating the above maximum aggregation if the inventory excursion amount is greater than the maximum goal;
said performing above maximum buffering comprises:
setting an starting buffer date to be current processing date,
determining a below maximum delta as the smallest difference between the new updated inventory projection and the maximum goal in an appropriate period starting from the starting buffer date,
determining an above minimum delta as the smallest difference between the new update inventory projection and the minimum goal in the appropriate period, and
updating, if the above minimum delta is greater than the below maximum delta, the net delta change based on the difference between the below maximum delta and the above minimum delta, the inventory backlog, and the cumulative net delta changes on the starting buffer date.

12. A system for supply line management, comprising:
an inventory projection mechanism for generating inventory projection based on the supply line information; and
a net delta recommendation mechanism for generating net delta recommendations based on both the supply line information, retrieved from the supply line information storage, and the inventory projection, generated by the inventory projection mechanism.

13. The system according to claim 16, wherein the net delta recommendation mechanism comprises:
a net delta change adjustment mechanism for adjusting existing an net delta change to meet a target inventory; and
a net delta change gneration mechanism for generating a net delta change when an inventory excusion is detected.

14. The system according to claim 13, further comprising:
a net delta change aggregation mecahnism for aggregating net delta changes; and
a net delta change buffering mechanism for buffering net delta changes.

15. The system according to claim 14, further comprising:
a supply line information preparation mechanism for generating the supply line information.

16. A system for generating a net delta recommendation, comprising:
an net delta change adjustment mechanism for adjusting an existing net delta change to meet a target inventory based on the supply line information and an inventory projection; and
an net delta change gneration mechanism for generating a net delta change based on the supply line information and the inventory proection when either a below minimum inventory excusion, with respect to a minimum goal, or an above maximum inventory excursion, with respect to a maximum goal, is detected.

17. The system according to claim 16, wherein the net delta change generation mechanism comprises:
a below minimum excursion handler for generating a net delta change recommendation when the below minimum inventory excursion is detected; and
an above maximum excursion handler for generating a net delta change recommendation that minimizes above maximum excursion, when an above maximum excursion is detected.

18. The system according to claim 17, further comprising:
an net delta change aggregation mecahnism for aggregating net delta changes based on the net delta change recommendation generated by either the below minimum excursion handler or the above maximum excursion handler; and
an net delta change buffering mechanism for buffering net delta changes based on the net delta change recommendation generated by either the below minimum excursion handler or the above maximum excursion handler.

19. The system according to claim 18, wherein the net delta change aggregation mechanism includes at least one of:
a below minimm aggregation mechanism for aggregating net delta changes when the below minimum inventtory excursion is detected; and
an above maximum aggregation mechanism for aggregating net delta changes when the above maximum inventory excursion is detected.

20. The system according to claim 19, wherein the net delta change buffering mechanism includes at least one of:
a below minimm buffering mechanism for buffering net delta changes when the below minimum inventory excursion is detected; and
an above maximum buffering mechanism for buffering net delta changes when the above maximum inventory excursion is detected.

21. A machine-accessible medium encoded with data for supply line management, the data, when accessed, causing:
generating an inventory projection based on supply line information;
generating a net delta change recommendation based on the supply line information and the inventory projection.

22. The machine-accessible medium according to claim 21, the data, when accessed, further causing:
preparing, by a supply line information preparation mechanism, the supply line information prior to said generating the inventory projection.

23. A machine-accessible medium encoded with data for generating a net delta change recommendation, the data, when accessed, causing:
accessing supply line information and an inventory projection;
determining an appropriate calculation window;
adjusting, if there is a target inventory during a period within the calculation window, by an net delta change adjustment mechanism, the inventory projection to meet the target inventory; and
generating, if there is either a below minimum inventory excursion, with respect to a minimum goal, or an above maximum inventory excursion, with respect to a maximum goal, by an net delta change generation mechanism, an net delta recommendation to remove the excursion.

24. The medium according to claim 23, wherein said adjusting the inventory projection comprises:
obtaining the target inventory quantity of the inventory target from the supply line information;
increasing, if the inventory projection on the day prior to the target date of the inventory target is lower than the target inventory quantity, the net delta change of the current valid receiving day, to meet the target inventory;
decreasing, if the inventory projection on the day prior to the target date of the inventory target is higher than the target inventory quantity, the net delta changes in an appropriate period within the calculation winow through at least one of:
reducing positive net delta changes in the appropriate period without causing a below minimum excursion;
increasing negative net delta changes in the appropriate period without causing the below minimum excursion; and
creating negative net delta changes in the appropriate period without causing the below minimum excursion.

25. The medium according to claim 23, wherein said generating a net delta recommendation comprises:
determining the excursion type as either below minimum excursion or above maximum excursion;
handling, by a below minimum excursion handler, below minimum excurion, if the below minimum excursion is determined; and
handling, by a above maximum excursion handler, above maximum excursion, if the above maximum excursion is determined.

26. The medium according to claim 25, wherein said handling below minimum excursion comprises:
identifying the maximum below minimum delta within an appropriate period;
adding the maximum below minimum delta to the net delta change to generate an updated net delta change;
projecting inventory based on the updated net delta change to generate an updated invenory projection;
determining, based on the updated inventory projection, whether there is still an excursion and the corresponding excursion date;
performing below minimum aggregation, if a below minimum excursion is determined;
performing below minimum buffering; and
projecting inventory based on the results from the below minimum aggregation and the below minimum buffering.

27. The medium according to claim 26, wherein
said performing below minimum aggregation comprises:
determining a below minimum delta as the difference between a minimum goal and the updated inventory projection on the excursion date,
computing a below maximum delta as the minimum difference between a maximum goal and the updated inventory projection in an appropriate period,
adding, if the below minimum delta is greater than the below maximum delta, the below minimum delta to the net delta change,
projecting inventory, based on the updated net delta change, to produce a new updated inventory projection,
determining whether there is an inventory excursion and the corresonding inventory excursion date,
setting an appropriate buffer end date if the inventory excursion does not exist, and
repeating the below minimum aggregation if the inventory excursion is smaller than the maximum goal; and
said performing below minimum buffering comprises:
determining an above minimum delta as the smallest difference between the new updated inventory projection and the minimum goal in an appropriate period,
determining a below maximum delta as the smallest difference between the new update inventory projection and the maximum goal in the appropriate period, and
updating, if the below maximum delta is greater than the above minimum delta, the net delta change based on the difference between the below maximum delta and the above minimum delta.

28. The medium according to claim 25, wherein said handling above maximum excursion comprises:
computing an above minimum delta and an above maximum delta;
generating an net delta change for the excursion date based on the smallest value of the above minimum delta, the above maximum delta, and the inventory backlog;
determining whether the net delta change, generated by the generating, is equal to the above maximum delta;
projecting inventory based on the net delta change, generated by the generating, if the net delta change is equal to the above maximum delta, to generate an updated inventory projection;
determining, based on the updated inventory projection, whether there is still an excursion and its corresponding excursion date;
performing above maximum aggregation, if an above maximum excursion is determined;
performing above maximum buffering; and
projecting inventory based on the results from the above maximum aggregation and the above maximum buffering.

29. The medium according to claim 28, wherein
said performing above maximum aggregation comprises:
determining an above maximum delta as the difference between the maximum goal and the updated inventory projection on the excursion date,
computing an above minimum delta as the minimum difference between the minimal goal and the updated inventory projection in an appropriate period within the calculation window,
adding, if the above maximum delta is lower than the above minimum delta and the above maximum delta is lower than the inventory backlog, the above maximum delta to the net delta change to generate an updated net delta change,
projecting inventory, based on the updated net delta change, to produce a new updated inventory projection,
determining whether there is an inventory excursion and the corresonding inventory excursion date,
setting an appropriate buffer end date if the inventory excursion does not exceed the maximum goal, and
repeating the above maximum aggregation if the inventory excursion amount is greater than the maximum goal; and
said performing above maximum buffering comprises:
setting an starting buffer date to be current processing date,
determining a below maximum delta as the smallest difference between the new updated inventory projection and the maximum goal in an appropriate period starting from the starting buffer date,
determining an above minimum delta as the smallest difference between the new update inventory projection and the minimum goal in the appropriate period, and
updating, if the above minimum delta is greater than the below maximum delta, the net delta change based on the difference between the below maximum delta and the above minimum delta, the inventory backlog, and the cumulative net delta changes on the starting buffer date.
